(19) United States
(12) Patent Application Publication
(10) Pub. No.: US 2006/0214522 A1
(43) Pub. Date: Sep. 28, 2006

(54) Vehicle AC generator having connection portions of stator winding conductor segments oriented in accordance with direction of cooling air flow

(75) Inventor: Yusuke Kawano, Nagoya (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/358,067

(22) Filed: Feb. 22, 2006

(30) Foreign Application Priority Data
Mar. 22, 2005 (JP) 2005-080804

(51) Int. Cl. H02K 9/00; H02K 3/00

(52) U.S. Cl. 310/59; 310/201; 310/179

(57) ABSTRACT

A vehicle AC generator has a stator winding formed of series-connected U-shaped conductor segments, with a plurality of connection portions, each formed of a pair of connected tip portions of respective conductor segments, protruding axially at one end of the stator core, with a flow of cooling air being impelled outward from the rotor along a flow direction that deviates from a radial direction, to pass between the connection portions. Each connection portion is oriented along a direction that deviates from a radial direction, to reduce air flow resistance and reduce audible noise caused by the air flow.

### CROSS-REFERENCE TO RELATED APPLICATIONS

This application is based on and incorporates herein by reference Japanese Patent Application No. 2005-080804 filed on Mar. 22, 2005.

### BACKGROUND OF THE INVENTION

1. Field of Application

The present invention relates to an AC generator for installation in a motor vehicle such as a passenger automobile, truck, etc.

2. Description of Related Art

In recent years, due to the increased level of electrical load that is imposed on the AC generator (sometimes referred to as the alternator) of a motor vehicle by the use of safety control equipment etc., a requirement has arisen for increased generating capacity of such an AC generator. Types of rotary electric machine are known, designed to provide a higher level of operating capacity, in which each phase coil of the stator winding is formed of a plurality of conductor segments connected in series, each conductor segment basically formed in a U-shaped configuration. In that way each of the stator slots can be substantially completely filled by these conductor segments, so that the occupancy factor of each slot is higher than can be achieved with a conventional form of stator winding, and a higher operating capacity can thereby be achieved. In particular, a higher output power generating capability can be achieved. Such a rotary electric machine is described for example in Japanese patent publication No. 2001-204151 (pages 2-5, FIGS. 1-4).

With such a type of stator winding, tip portions of the control signal generating section are bent to an appropriate shape such that pairs of the conductor segments can be connected in series by attaching together respective tip portions (e.g., by welding). These pairs of connected protrude axially at one end of the stator core.

Such a rotary electric machine is generally provided with a pair of cooling fans, mounted at axially opposing ends of the rotor, for producing outward-directed flows of cooling air within the interior of the rotary electric machine. However when the stator winding is formed as described above from such successively connected U-shaped conductor segments, with the connection portions are disposed adjacent to the outer circumference of one of the fans, the connection portions (i.e., pairs of connected tip portions) of the conductor segments obstruct the flow of cooling air from the adjacent cooling fan.

This is a significant problem, since achieving effective cooling of the interior of the rotary electric machine is an important factor in attaining increased operating capacity.

Moreover, as a result of the flow of cooling air over the connection portions of the stator winding, an increased level of audible noise is generated, by comparison with a conventional type of stator winding which does not incorporate such connection portions.

### SUMMARY OF THE INVENTION

It is an objective of the present invention to overcome the above disadvantages of the prior art by providing an AC generator for installation in a motor vehicle (referred to in the following simply as a vehicle AC generator) having a stator winding formed of sets of basically U-shaped conductor segments as described above, but whereby the degree of obstruction of a flow of cooling air due to the presence of the connection portions of the stator winding conductor segments can be substantially reduced, and the level of noise due the cooling air passing over the connection portions can also be reduced.

To achieve the above objectives, the invention provides a vehicle AC generator comprising a rotor (in general, rotated by the vehicle engine), a stator having a stator iron core fixedly disposed opposing the stator, a stator winding disposed in the stator iron core, and a frame which supports the rotor and stator. The stator winding is made up a plurality of conductor segments, each basically formed in a U-shaped configuration having two linear portions that are connected by a turn portion and that extend to respective tip portions, with pairs of the tip portions of respective conductor segments being connected together. According to a first aspect of the invention, such a pair of connected tip portions are oriented along a direction that is inclined with respect to a radial direction of the stator. More specifically, a line (in a plane at right angles to the stator axis) extending between respective centers of such a pair of connected tip portions is inclined with respect to a radial direction of the stator.

In that way, when a flow of cooling air is generated by utilizing rotation of the rotor and passes through the pairs of connected tip portions of the conductor segments, with the air flow being along a direction which is angularly displaced from a radially outward direction, it can be ensured that the amount of resistance presented to the cooling air flow by the tip portions of the conductor segments is reduced, while in addition the level of audible noise resulting from the flow of cooling air over the tip portions of the conductor segments.

From another aspect, each of the conductor segments preferably has a cross-sectional shape that is substantially rectangular, and each connected pair of adjacent tip portions has a pair of substantially circumferentially opposing faces which are respectively flat and are each oriented along the aforementioned direction that is inclined with respect to a radial direction of the stator.

Typically, such an AC generator comprising a cooling fan mounted on an (axial) end face of the rotor, for producing the aforementioned flow of cooling air, i.e. by drawing a flow of cooling air from the exterior, towards inner parts of the rotor, and impelling the cooling air axially outward, along a direction that is inclined with respect to a radial direction of the rotor. With the present invention, the orientation direction of each connected pair of tip portions of the conductor segments is set in accordance with the direction in which the flow of cooling air is impelled outward (i.e., with that flow direction being measured as an angular deviation from a radial direction of flow).

From another aspect, when such a type of fan is utilized then in each pair of connected tip portions of conductor segments, the radially outer tip portion of the pair is preferably positioned ahead of the radially inner tip portion of the pair, with respect to the direction of rotation of the rotor. The resistance to the flow of cooling air can thereby be further decreased.

From another aspect, the frame of such a vehicle AC generator is preferably formed with a plurality of ventilation apertures such as an annular array of ventilation apertures, that are disposed radially outward from the pairs of connected tip portions (for example, with each of the ventilation apertures being located in correspondence with and closely adjacent to a space between two circumferentially adjacent pairs of the connected tip portions), and with each of respective circumferentially opposing faces of each of the ventilation apertures being oriented along a substantially identical direction to an orientation direction of a corresponding one of the radially adjacent pairs of tip portions.

In addition, each of the ventilation apertures preferably has the shape of an outward extension of a space formed between two circumferentially adjacent pairs of the radially adjacent connected tip portions, when that space is extended along a direction that is inclined by the aforementioned angular amount from a radial direction of the stator.

### BRIEF DESCRIPTION OF THE DRAWINGS

FIG. 1 is a cross-sectional view showing the overall configuration of an embodiment of a vehicle AC generator;

FIG. 2 is a cross-sectional view of the stator of this embodiment;

FIG. 3 is an oblique view conceptually illustrating conductor segments which are installed in a stator iron core of the embodiment;

FIG. 4 is a partial oblique view showing connection portions of conductor segments, at one end of the stator; and

FIG. 5 is a plan view of the connection portions of the conductor segments.

### DESCRIPTION OF PREFERRED EMBODIMENTS

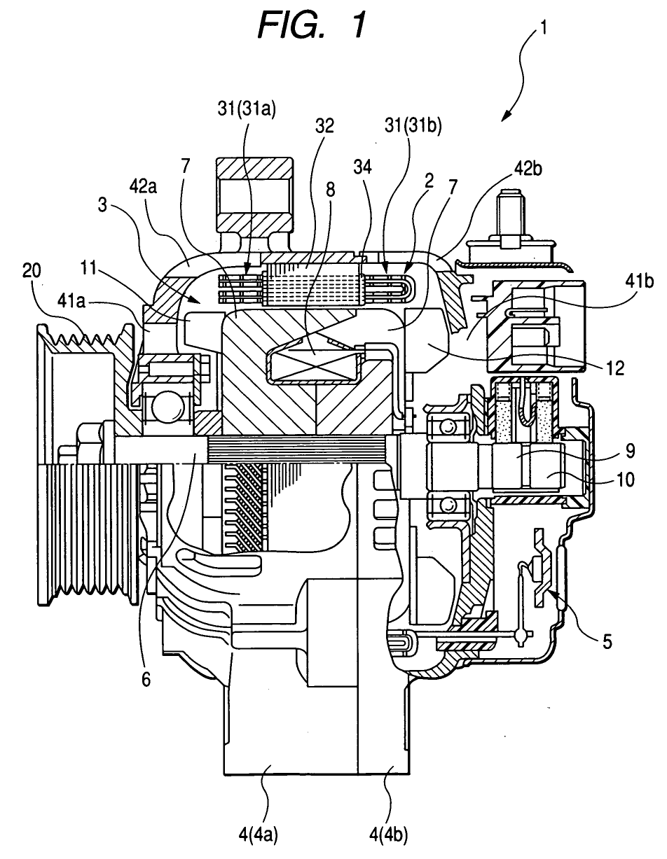

An embodiment of a vehicle AC generator will be described referring first to the overall configuration shown in the cross-sectional view of FIG. 1. The vehicle AC generator 1 of FIG. 1 is basically made up of a stator 2, a rotor 3, a frame 4, a rectifier apparatus 5 and a rotor shaft 6. The rotor 3 produces field magnet poles, and is fixedly attached to the rotor shaft 6, to be rotated thereby. The rotor 3 is made up of a Lundel type of pole core 7 (i.e., having a toothed circumferential configuration), a field coil 8, slip rings 9, 10, and a radial cooling fan 11 and centrifugal fan 12, for producing flows of cooling air.

The rotor shaft 6 has a pulley 20 fixedly mounted axially thereon, which is coupled to the engine (not shown in the drawings) of a vehicle in which the vehicle AC generator 1 is installed, to drive the rotor shaft 6 for rotation. The Lundel pole core 7 is configured with a set of pole cores. The angled-flow fan 11, which is located at the same end of the rotor shaft 6 as the pulley 20, is fixedly attached to an end face of the Lundel pole core 7, for example by welding. The angled-flow fan 11 has vanes which are oriented at an acute angle with respect to the corresponding end face of the Lundel pole core 7.

The centrifugal fan 12, which is located at the opposite end of the rotor 3 from the pulley 20, is fixedly attached to an end face of the Lundel pole core 7, e.g., by welding, and has vanes that are oriented at right angles to that end face.

The frame 4 is made up of a front frame 4a and a rear frame 4b, with ventilation intake apertures 41a, 41b being respectively formed in axially opposing side walls of the front frame 4a and rear frame 4b respectively. A set of ventilation exhaust apertures 42a (in this embodiment, configured as an annular array of apertures arranged at regular circumferential spacings) is formed in a shoulder portion of the front frame 41a, disposed radially outward from the ventilation intake aperture 41a and adjacent to a first coil end group 31a (described hereinafter), while ventilation exhaust apertures 42b are similarly formed in the rear frame 41b.

The rotor 3 and stator 2 are respectively supported by the frame 4.

A stator iron core 32 of the stator 2 is fixedly attached to the front frame 4a, and has a stator winding 31 mounted therein, with the stator winding 31 being formed of series-connected basically U-shaped conductor segments as described hereinafter. A first coil end group 31a of the stator winding 31, containing connection portions (described hereinafter) between respective conductor segments, protrude axially outward from one end of the stator iron core 32 as shown, while an axially opposing second coil end group 31b (made up of respective continuous curved portions of the conductor segments, referred to herein as the turn portions) protrude from the opposite end of the stator iron core 32. The coil end group 31a are located to receive a flow of cooling-air from the angled-flow fan 11, with the air flow exiting through the ventilation apertures 42a. The centrifugal fan 12 similarly induces a flow of cooling air through the second coil end group 31b, which exits through the ventilation apertures 42b.

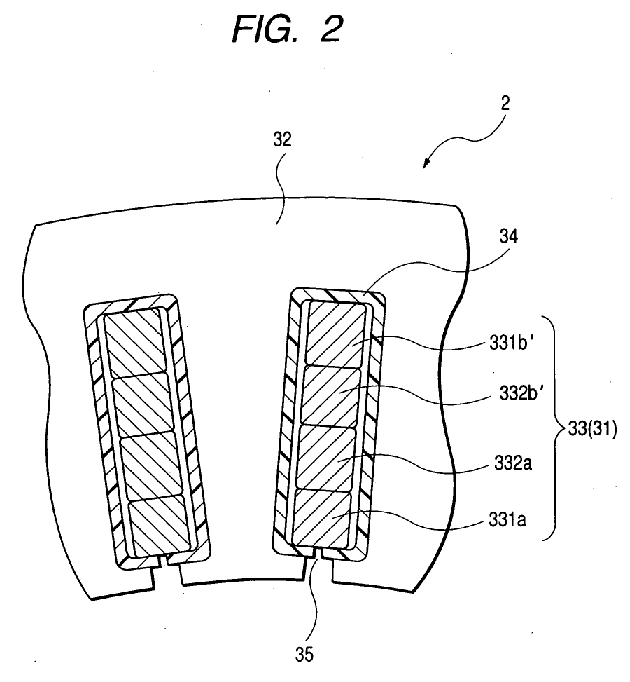

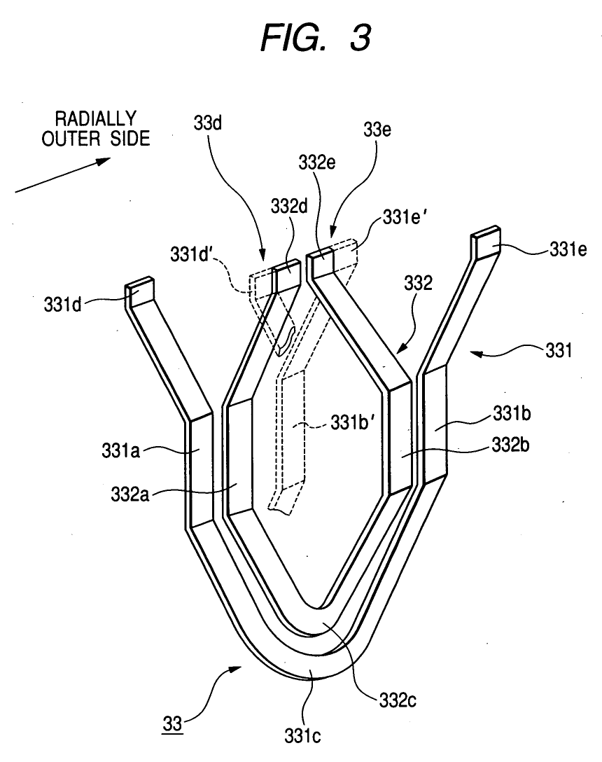

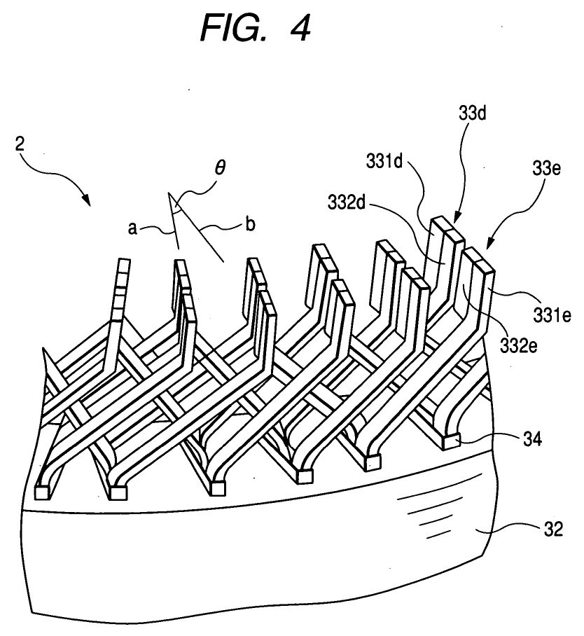

The stator 2 will be described in greater detail in the following. FIG. 2 is a partial cross-sectional view of the stator 2, taken in a plane at right angles to the axial direction, while FIG. 3 is an oblique view which conceptually illustrates a basic pair of conductor segments 33 which are mounted in the stator iron core 32, representative of a plurality of such basic pairs that are mounted therein. FIG. 4 is a partial oblique view of the first coil end group 31a, showing the connection portions between respective conductor segments, with linearly extending portions of the conductor segments being contained within slots 35 of the stator iron core 32 as illustrated in FIG. 2, separated from the stator iron core 32 by a layer of electrical insulation material 34.

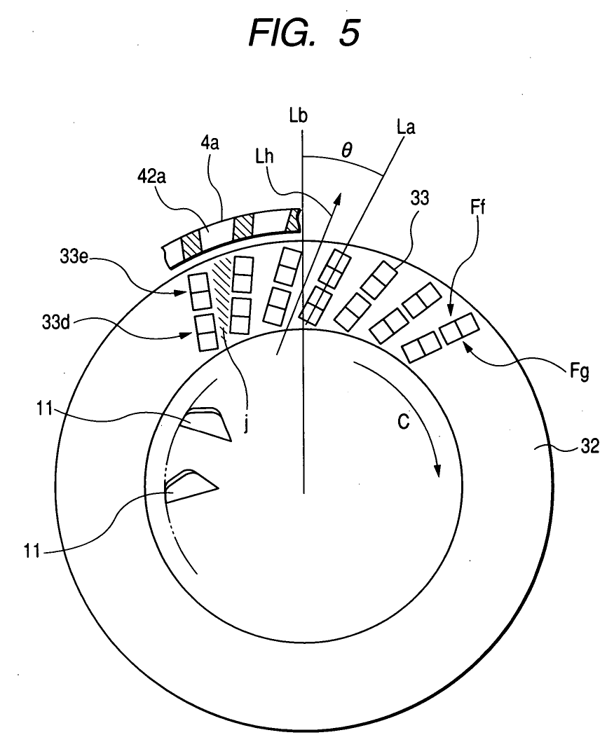

Each stator slot 35 is an axially extending slot formed in the inner periphery of the stator iron core 32, having a substantially rectangular cross-sectional shape as shown in FIG. 5, and accommodates a plurality of linearly extending portions of respective conductor segments) with these linear portions constituting successive conductor layers within each stator slot 35, which successively extend radially inward with respect to the axis of the stator iron core 32 as shown in the cross-sectional view of FIG. 2.

In this embodiment, linear portions of a total of four conductor segments are accommodated in each stator slot 35, i.e., the conductor portions 331a, 332a, 332b′, 331b′ in the example of FIG. 2, extending successively radially outward as shown in FIG. 2. These will be respectively referred to as the innermost layer (331a in the example of FIG. 2), the inner center layer (332a), the outer center layer (332b′), and the outermost layer (331b′). The stator winding 31 is formed by interconnecting the conductor segments in a specific pattern. It can be understood from FIGS. 3 and 4 that the above-described first coil end group 31a of the stator winding 31 contains a plurality of such pairs of connection portions 33d, 33e which are each formed of a connected pair of the tip portions (331d, 331e, 332d, 332e) of respective conductor segments 33.

The second coil end group 31b is made up of the continuous curved portions 331c, 332c (referred to herein as turn portions) of respective conductor segments 33, as shown in FIG. 3.

It can thus be understood that each conductor portion disposed as an innermost layer within a stator slot 35 (e.g., the portion 331a of the conductor segment 331 as seen in FIG. 2) is paired with another conductor portion (e.g., the conductor portion 331b) which constitutes the outermost layer within a slot 35 that is circumferentially spaced apart from the first-mentioned slot 35 by a fixed amount. With this embodiment, that amount is one pole pitch. Similarly, there is a circumferential spacing of one pole pitch (moving in the clockwise direction) between the pair of slots 35 which contain portions 332a and 332b of a conductor segment 332 as the inner center layer and the outer center layer, respectively.

As shown in FIG. 3, each turn portion (e.g., 331c) of a conductor segment that forms an innermost layer and outermost layer, respectively, in a pair of slots spaced apart by one pole pitch, is disposed around a turn portion (e.g., 331c) of a conductor segment that forms the inner center layer and the outer center layer, respectively, in that pair of slots. In that way, the second coil end group 31b of FIG. 1 is formed of intermediate-layer turn portions, each connecting an inner center layer and outer center layer in respective slots (spaced apart by one pole pitch) and outer-layer turn portions, each connecting an innermost layer and outermost layer in respective slots (spaced apart by one pole pitch)

Also as can be understood from FIG. 3, each connection portion such as the connection portion 33d is formed between a conductor segment tip portion (e.g., 332d) that extends from an inner center layer of a first slot and a conductor segment tip portion (e.g., 331d′) that extends from an innermost layer of a second slot. Similarly, each connection portion such as the connection portion 33e is formed between a conductor segment tip portion (e.g., 332e) that extends from an outer center layer of a first slot and a conductor segment tip portion (e.g., 331e′) that extends from an outermost layer of a second slot.

It will be understood that the term “connection” as used herein, applied to an attachment between two tip portions of respective conductor segments, has the significance of both electrical connection and mechanical connection, e.g., as achieved by welding the two tip portions together.

In addition, each conductor portion 332a, forming an inner center layer of a stator slot 35, is paired with a conductor portion 331a′ (not shown in the drawings)), that is the innermost layer within a stator slot 35 that is spaced apart by 1 pole pitch (moving in the clockwise direction of the stator iron core 32). Similarly, each conductor portion 331b′, forming an outermost layer in a stator slot 35, is paired with a conductor portion 332b, that is the outer center layer within a stator slot 35 that is spaced apart by 1 pole pitch (moving in the clockwise direction of the stator iron core 32).

As can further be understood from FIG. 3, this is achieved by connecting respective pairs of axially adjacent conductor tip portions (e.g., connecting together the pair 332d, 331d′, and connecting together the pair 332e, 332e′ as illustrated).

As can be understood from FIGS. 4 and 5, the tip portions of respective conductor segments are shaped such that the connection portion 33d which connects the conductor portion 331a′ (which is an outermost layer in a stator slot 35) to the conductor portion 332a (which is an outer center layer in a slot) and the connection portion 33e which connects the conductor portion 331b′ (which is an innermost layer in a slot) to the conductor portion 332b (which is an inner center layer in a slot), are oriented along a line which slopes with respect to a radial direction of the stator (i.e., a radial direction with respect to the rotor axis). This is clearly illustrated in FIGS. 4 and 5.

More precisely, (in general, irrespective of the cross-section shape of the conductor segments) a line (in a plane at right angles to the stator axis) that connects respective centers of a pair of tip portions constituting a connection portion is inclined with respect to a radial direction of the stator, for example by the angle θ shown in FIG. 5, described hereinafter, and in addition with this embodiment, a line connecting respective centers of a substantially radially adjacent pair of connection portions 33d, 33e is similarly inclined with respect to a radial direction.

With this embodiment, each of the conductor segments has a substantially rectangular cross-section, as shown in FIG. 2, of uniform thickness, and is basically configured in a predetermined U-shape. Specifically, as shown in FIG. 3, each of the large segments 331 has a substantially U-shaped configuration that is appropriate for disposing the linear conductor portions 331a, 331b of each such conductor segment as the innermost layer and outermost layer in respective slots 35, while each of the small segments 332 has a substantially U-shaped configuration that is appropriate for disposing the linear conductor portions 332a, 332b of each such conductor segment as the inner center layer and outer center layer in respective slots 35. A pair of large and small conductor segments 331, 332 such as those of FIG. 3, which share a pair of slots 35 that are spaced apart by one pole pitch, will be referred to as a basic pair of the conductor segments 33.

As shown in FIG. 4, each tip portion of a large segment 331 of a basic segment pair is connected to an axially adjacent tip portion of a small segment 332 of a circumferentially succeeding basic segment pair. With this embodiment, as is clear from FIG. 4 (with each conductor segment 33 spanning one pole pitch), the slot pitch is ⅓ of the pole pitch. The conductor segments 33 are successively connected as described above, with a set of sequentially connected (large, small) conductor segments thereby constituting a two-turn coil (i.e., extending circumferentially twice around the stator iron core 32). With this embodiment there are three of such sets, respectively differing in circumferential position by ⅓ pole pitch, as can be understood from FIG. 4. Hence, the stator winding 31 is a 3-phase winding formed of three two-turn coils.

A more detailed description of the stator winding 31 and of the connection portions 33d, 33e, will be given in the following. Referring to the partial oblique view of FIG. 4 and the plan view of FIG. 5, La indicates a straight line along which each radially adjacent pair of connection portions 33d, 33e are oriented, while Lb indicates a radial direction in the stator 2, θ indicates the angle between the directions of lines La and Lb. Also in FIG. 5, the curved arrow line C indicates the direction of rotation of the rotor 3.

As shown in FIGS. 4 and 5 and described above, each connection portion 33d is formed of two adjacent tip portions 331d, 332d of respective conductor segments, while each connection portion 33e is formed of two adjacent tip portions 331e, 332e of respective conductor segments. Preferably, as with this embodiment, each set of adjacent tip portions 331d, 332d, 332e, 331e are oriented along a direction that is angularly displaced by the angle θ from a radial direction of the stator iron core 32, where the value of θ is preferably determined in accordance with a cooling air flow direction as described hereinafter.

In addition, respective opposing faces (with respect to the circumferential direction) of the tip portions 331d, 332d, 332e, 331e, are flat and mutually parallel, with each of these flat faces being oriented along a direction that is angularly displaced by the aforementioned angle θ from a radial direction of the stator iron core 32. As a result, each of the connection portions 33d, 33e is formed with substantially flat opposing faces (with respect to the circumferential direction), e.g., the opposing faces Ff, Fg indicated in FIG. 5, with each of these flat faces being inclined by the amount θ with respect to a radial direction of the stator iron core 32.

The extent of this of inclination with respect to radial direction of the stator iron core 32 is by the extent to which the position of the outer tip portion (e.g., the tip portion 331e) in each connection portion is advanced with respect to the position of the inner tip portion (e.g., the tip portion 331d) of that connection portion, in relation to the direction of rotation of the rotor 3 (indicated by the arrow line C in FIG. 5).

Alternatively, the extent of this inclination (i.e., the value of the angle θ) can be can be considered as being determined by the extent to which the position of the outer connection portion (e.g., the connection portion 33e) in each radially adjacent pair of connection portions connection is advanced with respect to the position of the inner connection portion (e.g., the connection portion 33d) of that pair of connection portions, in relation to the direction of rotation of the rotor 3.

As partially illustrated in FIG. 5, the aforementioned angled-flow fan 11 that is mounted on an axial end face of the Lundel pole core 7 of the rotor 3 (i.e., at the end opposite to the pulley 20) includes fan vanes that protrude outward from that end face, oriented at an acute angle with respect to the end face. Thus when the Lundel pole core 7 rotates in the direction indicated by the arrow line C, a flow of cooling air is induced along the direction indicated as Lh, i.e., a direction that is inclined by the angular amount θ with respect to a radial direction of the stator iron core 32. With this embodiment, the angle of inclination of the opposing faces of the connection portions 33d, 33e, is predetermined to be in accordance with the direction of outward flow of the cooling air from the angled-flow fan 11.

Furthermore with this embodiment, as partially shown in FIG. 5, the central axis of each aperture in the array of apertures 42a described above extends along a direction that is inclined by the angular amount θ with respect to a radial direction of the stator iron core 32. In this case, the “central axis” is defined as a line (in a plane taken at right angles to the axis of the stator iron core 32) that is equidistant between the circumferentially opposing sides of an aperture 42a.

As can also be understood from FIG. 5, each of the apertures 42a varies in circumferential width, and is oriented with respect to the stator iron core 32, such that each aperture 42a (as seen in cross-section, taken at right angles to the axial direction of the stator iron core 32) has the shape of an outward extension of a region Sj (indicated by the hatched-line region in FIG. 5) that is formed between two circumferentially adjacent pairs of the connection portions 33d, 33e, if that region is extended along a direction (corresponding to the axis line Lh in FIG. 5) that is inclined by the aforementioned angular amount θ with respect to a radial direction of the stator iron core 32.

Furthermore with this embodiment, each of the ventilation apertures 42a is circumferentially positioned in correspondence with such a region Sj.

In that way, due to the manner in which each pair of radially adjacent connection portions 33d, 33e are oriented at an appropriate angle with respect to a radial direction, a significant reduction can be achieved in the amount of resistance that is presented by the connection portions 33d, 33e to a correspondingly oriented outward flow of cooling air from the angled-flow fan 11.

Furthermore in addition to this lowering of air flow resistance, the amount of audible noise that results from the flow of air past the connection portions 33d, 33e can be substantially reduced. Hence, the AC generator can have improved cooling performance, together with a lower level of audible noise.

Moreover with this embodiment, due to the fact that each of the conductor segments 33 (in particular, each of the tip portions 331d, 331e, etc.) is formed with a substantially rectangular cross-sectional shape, each of the connection portions 33d, 33e can have circumferentially opposing faces that are substantially flat and are each oriented at an appropriate angle with respect to a radial direction of the stator. The resistance to the flow of cooling air can thereby be further decreased.

As described above, the orientation direction of each pair of radially adjacent connection portions 33d, 33e is determined in accordance with the direction of the flow of cooling air that is produced by the angled-flow fan 11 of the rotor 3. Specifically, that orientation is such that the position of the outermost connection portion (33e) of a radially adjacent pair (or the outermost tip portion 331e in the outermost connection portion 33e) is advanced along the direction of rotation of the rotor 3, in relation to the inner connection portion 33d of that pair, as illustrated in FIG. 5. The resistance to a cooling air flow can thereby be reduced, in the case of an internal-vane type of vehicle AC generator, in which cooling air flows outward with respect to the rotor, along a direction that is displaced from a radial direction of the rotor. Reduced audible noise and lower temperature operation of the AC generator can thereby be achieved.

Furthermore as described above, each of the ventilation apertures 42a is oriented along a direction having the same angular difference from a radial direction as each of the connection portions 33d, 33e, and has the shape of a radially outward extension of a space formed between two circumferentially adjacent pairs of the connection portions 33d, 33e. Hence there is a lowered level of resistance to a flow of cooling air that passes from the interior of the front frame 4a, through the stator winding 31 and the apertures 42a to the exterior.

It should be noted that the present invention is not limited to the above embodiment, and that various modifications could be envisaged to that embodiment. For example, each of the connection portions 33d, 33e could be covered by layer of electrical insulation material such as synthetic resin, etc. In that case also, the principles of the present invention described above can be applied to the gap between each pair of circumferentially adjacent connection portions 33d and each pair of circumferentially adjacent connection portions 33e.

What is claimed is:

1. An AC generator for installation in a vehicle, comprising a rotor that is driven for rotation, a stator having a stator iron core fixedly disposed opposing the stator, a stator winding disposed in said stator iron core, and a frame which supports said rotor and stator, said stator winding comprising a plurality of conductor segments each basically formed in a U-shaped configuration having two linear portions that are connected by a turn portion and that extend to respective tip portions, with pairs of said tip portions of respective conductor segments being connected together;
wherein each said pair of connected tip portions are oriented along a direction that is inclined by a specific angular amount with respect to a radial direction of said stator.

2. An AC generator as claimed in claim 1, wherein each of said conductor segments has a cross-sectional shape that is substantially rectangular, and wherein each said connected pair of tip portions of conductor segments has a pair of opposing faces thereof, with respect to a circumferential direction of said stator, which are respectively flat and each oriented along said direction that is inclined with respect to a radial direction of said stator.

3. An AC generator as claimed in claim 1, comprising a cooling fan mounted on an axial end face of said rotor, for drawing a flow of cooling air inward with respect to an axis of said rotor and impelling said cooling air outward with respect to said rotor axis;
wherein said orientation direction of each said connected pair of radially adjacent tip portions is set in accordance with an amount of angular difference between a direction of said outward flow of said cooling air and a radial direction of said rotor.

4. An AC generator as claimed in claim 3 wherein in each of said pair of connected tip portions of conductor segments, a radially outer tip portion of said pair is positioned in advance of a radially inner tip portion of said pair, with respect to a direction of rotation of said rotor.

5. An AC generator as claimed in claim 1, wherein said frame is formed with a plurality of ventilation apertures disposed radially outward from said pairs of connected tip portions, wherein each of said ventilation apertures is oriented along a direction that is inclined by a specific angular amount, with respect to a radial direction of said stator, that is substantially identical to said amount of inclination of each of said pairs of connected tip portions.

6. An AC generator as claimed in claim 5, wherein each of said ventilation apertures has the shape of an outward extension of a space formed between two circumferentially adjacent pairs of said radially adjacent connected tip portions, when said space is extended along a direction that is inclined by said angular amount from a radial direction of said stator.

7. An AC generator as claimed in claim 1, wherein
said linear portions of said-conductor segments are contained within a plurality of slots formed in said stator iron core, with respective ones of said linear portions constituting successive conductor layers within each of said slots; and
a plurality of sets of pairs of connected tip portions of said conductor segments are disposed at one axial end of said stator iron core, each said set comprising a plurality of successively adjacent ones of said pairs of connected tip portions, respectively extending axially outward from said end of said stator iron core, with said pairs of connected tip portions of said each set being successively arrayed in line along a direction which is inclined by said angular amount with respect to a radial direction of said stator.
